(19) United States
(12) Patent Application Publication
(10) Pub. No.: US 2025/0375763 A1
(43) Pub. Date: Dec. 11, 2025

(54) PIPETTE

(71) Applicant: Festo SE & Co. KG, Esslingen (DE)

(72) Inventor: Daniel ROCHA POLI, Westford, MA (US)

(21) Appl. No.: 18/734,682

(22) Filed: Jun. 5, 2024

(51) Int. Cl. B01L 3/02

(52) U.S. Cl. CPC B01L 3/0279

(57) ABSTRACT

A pipette for dispensing liquids, including a fluid tube which extends along a tube axis and has at a first end region a guide section in the shape of a circular cylinder or conical section. The guide section is provided with a guide groove extending along the tube axis, in which a latch is movably mounted in the guide groove between a latch position and a release position, in which the latch has a latch body extending along the guide groove and a latch hook projecting radially outwards from the latch body. The latch hook is arranged in the guide groove in the release position and the latch hook projects radially outwards beyond the guide section in the latch position.

The invention relates to a pipette for dispensing liquids.

DE 19917375 A1 discloses a disposable pipette tip for attachment to a pipetting unit, wherein the disposable pipette tip has a jacket and a through opening enclosed by the jacket and the through opening extends along a longitudinal axis between a first end face of the disposable pipette tip intended for immersion in and contact with the medium to be pipetted and a second end face of the pipette tip lying opposite in the axial direction, wherein the pipette tip has a coupling region near the second end for coupling with a coupling attachment of the pipetting unit and the jacket of the disposable pipette tip has an axial positioning means in the coupling region which is intended for cooperation with a complementary counter-axial positioning means of the pipette attachment and defines an axial coupling position of the pipette tip on the pipetting unit.

### SUMMARY OF THE INVENTION

The task of the invention is to provide a pipette which enables improved handling of pipetting tips.

This task is solved by a pipette, comprising a fluid tube which extends along a tube axis and has, at a first end region, a guide section which is designed in the shape of a circular cylinder or conical section, wherein the guide section is provided with a guide groove extending along the tube axis, a latch being mounted in the guide groove so as to be movable between a latch position and a release position, wherein the latch has a latch body extending along the guide groove and a latch hook projecting radially outwards from the latch body, wherein the latch hook is arranged/received in the guide groove in the release position and wherein the latch hook projects radially outwards beyond the guide section in the latch position.

The fluid tube represents a central component of the pipette and can, for example, be accommodated in a manual pipette that is gripped and operated directly by hand by a user to enable handling of a liquid. Alternatively, one or more fluid tubes may be included in a pipetting device for automated handling of liquids.

The fluid tube extends along a tube axis, which is preferably designed as a straight line, but can also be curved in some areas. Preferably, the fluid tube has a circular cross-section in a cross-sectional plane aligned transverse to the pipe axis. Alternatively, the fluid tube may have a cross-section that deviates from a circular shape, in particular oval or polygonal. Preferably, the fluid tube is made from a metallic material, for example stainless steel, or from a plastic material.

A guide section is formed at a first end region of the fluid tube, which guide section has a circular cylindrical shape or a conical section shape. The guide section is preferably manufactured as a separate component, in particular made of metal or plastic, and is fixed to an outer surface of the fluid tube, in particular with a material fit or a force fit. Alternatively, the guide section is formed directly by the fluid tube, i.e. is formed in one piece with the fluid tube. It is preferable that the guide section is aligned coaxially to the tube axis of the fluid tube. It is particularly preferred that the fluid tube is circular-cylindrical and that the guide section is either circular-cylindrical or conical in shape.

The guide section is provided with at least one guide groove extending along the axis of the tube, which guide groove is introduced into the guide section in a radial inward direction and extends at least partially along the guide section. It is preferable for the guide groove to have a U-shaped cross-section, in particular a rectangular cross-section, in a cross-sectional plane aligned transversely to the tube axis. The guide groove is used to accommodate a latch, which latch is movably accommodated in the guide groove and can be moved between a latch position and a release position. The latch has a latch body extending along the guide groove, which latch body is adapted to the cross-section of the guide groove in such a way that the latch has only one translational degree of freedom of movement along the tube axis and a further translational degree of freedom of movement in the radial direction transverse to the tube axis. Furthermore, the cross-sections of the guide groove and the latch body are matched to each other in such a way that no significant rotational movement can take place between the latch body and the guide groove parallel to the tube axis or in the radial direction. If necessary, provision can be made for a rotational degree of freedom for the latch body relative to the guide groove about an axis of rotation that is aligned transverse to the tube axis and transverse to the radial direction.

In addition to the preferably strip-shaped latch body, the latch comprises a latch hook which projects outwards in the radial direction from a radially outwardly aligned surface of the latch body. The task of the latch hook is to ensure a positive coupling in the latch position with a disposable pipetting tip (afterwards named: pipetting tip) arranged at the first end region of the fluid tube, so that the pipetting tip can be held reliably on the guide section, in particular also in the case of force effects along the tube axis. The latch body and the latch hook are adapted to the guide section and the guide groove therein in such a way that the latch hook is arranged or received in the guide groove in the release position for the latch. This can be expressed by the fact that, in the release position, the latch hook lies within an envelope geometry that is determined by an outer surface of the guide section and the latch hook does not intersect with this envelope geometry. In contrast, the latch hook protrudes outwards beyond the guide section in a radial direction in the latch position. This can be expressed by the fact that the latch hook in the latch position penetrates the envelope geometry, which is determined by the outer surface of the guide section, in a radial outward direction. This means that the overall cross-section of the guide section and latch in the cross-sectional plane aligned transverse to the tube axis is smaller in the release position than in the latch position.

It is preferable that the latch hook and the latch body are formed in one piece. It is particularly preferred that the latch has an essentially L-shaped cross-section in a cross-sectional plane spanned by the tube axis and the radial direction.

Advantageous further embodiments of the invention are the subject of the subclaims.

It is expedient if a first orifice is formed at the end of the first end region of the fluid tube and if the latch hook in the release position is located in a release distance to the first orifice and if the latch hook in the latch position is located in a latch distance to the first orifice, wherein the latch distance is greater than the release distance. The mouth opening can be arranged directly on an axially aligned end face of the guide section. It is preferable that the fluid tube extends beyond the guide section along the tube axis and that the orifice is thus arranged at a distance from the axially aligned end face of the guide section. The latch is moved during a relative movement between the release position and the latch position, whereby this movement can comprise both an axial component along the tube axis and a radial component in a radial direction transverse to the tube axis or alternatively an axial component along the tube axis and a swivel movement about a swivel axis that is aligned transverse to the tube axis and the radial direction. By increasing the distance which the latch hook has in the release position relative to the orifice and which is referred to as the release distance to the distance which the latch has in the latch position relative to the orifice and which is referred to as the latch distance, the latch can move a pipetting tip in the direction of the guide section due to the positive engagement of the latch hook in an undercut formed on the pipetting tip. It is preferably provided that the pipetting tip can be pulled onto the guide section by the movement of the latch between the release position and the latch position.

Preferably, the fluid tube has a cone-shaped sealing section which projects from the guide section along the axis of the tube and is tapered towards the first end region of the fluid tube. The function of the sealing section is to ensure a fluid-tight coupling between the fluid tube and the pipetting tip when the latch has arrived in the latch position and the pipetting tip is thus in a firm contact with the guide section, in particular when it is pulled onto the guide section. It is provided that the sealing section is tapered from the guide section to the mouth opening in order to be able to utilize a wedge effect when the pipetting tip is pushed onto the fluid tube, by means of which an elastic deformation of the pipetting tip, which is typically made of a plastic material, is to be brought about. Due to this elastic deformation the sealing effect between the pipetting tip and the sealing section is achieved. In a cross-sectional plane that includes the tube axis, the sealing section can have a partially conical cross-section or a partially parabolic cross-section. If necessary, the sealing section is provided with an elastic coating to improve the sealing effect.

It is advantageous if a coupling part, which is connected to the latch and is designed to transmit an actuating movement to the latch, is arranged on the fluid tube so that it can move linearly along the axis of the pipe. Preferably, the coupling part is in turn connected to an actuator which is designed to initiate a translational movement on the coupling part, with the translational movement preferably being aligned parallel to the tube axis. For example, the coupling part is designed as a sleeve which coaxially surrounds the fluid tube and a coupling effect is provided between the coupling part and the latch, wherein this coupling effect allows the transmission of, preferably axially oriented, tensile forces and compressive forces. Preferably, the coupling part and the latch are connected to each other via a linkage, so that, for example, an exclusively linear degree of freedom of movement for the coupling part, which is aligned along the axis of the tube, does not lead to the latch being restricted to this linear degree of freedom of movement. Rather, it can be provided, for example, that the linkage, in particular an articulated connection, between the coupling part and the latch enables the latch to pivot about a pivot axis which is aligned transversely to the tube axis and transversely to the radial direction.

In a further development of the invention, it is provided that a first control surface is formed on the latch and that a second control surface is formed on the guide section, the first control surface and the second control surface abutting one another at least in certain areas and forming a link guide or slotted link, with which a movement of the latch along the axis of the tube is superimposed with a movement of the latch transverse to the axis of the tube, in particular in radial outwardly direction. The task of the first control surface and the second control surface is to cause a superimposed translational movement or swivel movement during a translational relative movement of the latch along the tube axis between the release position and the latch position and in the opposite direction, with which the latch hook can be moved in the radial direction, in particular in radial outwardly direction. This superimposed movement takes place at least partially along a movement path that the latch covers between the release position and the latch position. Furthermore, the interaction between the first control surface and the second control surface causes a forced movement of the latch in the radial direction relative to the guide section. In this case, it may be provided that the first control surface and the second control surface are adapted to each other in such a way that a positive guidance between the latch and the guide section is ensured along the entire movement path. Alternatively, it can be provided that the first control surface and the second control surface are adapted to each other in such a way that positive guidance between the latch and the guide section is only provided over part of the movement path.

A slotted guide between the latch and the guide section can be realized, for example, by the latch being provided with a recess, for example a groove or an elongated hole, which is formed with a constant profile transverse to the tube axis and that the first control surface is determined by an inner surface of the recess and that a pin aligned transverse to the tube axis is fixed to the guide section, which passes through the recess and an outer surface of the pin forms the second control surface. The recess has an inner surface which can be used, at least in some areas, for contact with an outer surface of the pin, whereby these areas of the inner surface of the recess are also referred to as the first control surface. Those areas of the outer surface of the pin that come into contact with the inner surface of the recess during the relative movement between the latch and the guide section are referred to as the second control surface. It is preferable that both the first control surface and the second control surface form a closed surface area, i.e. without interruptions. Such a design of the first control surface and the second control surface exists in particular if a forced movement between the latch and the guide section is ensured continuously over at least a partial section of the movement path. It is preferable for the recess to have an extension path in a transverse sectional plane, which is spanned by the tube axis and the radial direction, in the form of a straight line or curve, which at least in some areas defines an acute angle with the tube axis. If, for example, the recess is produced using a milling process, the extension path corresponds to a milling path that a milling cutter must follow in order to create the recess in the latch. It is also intended that the recess has a constant cross-section in further transverse sectional planes that are aligned parallel to the cross-sectional plane spanned by the tube axis and the radial direction.

It is expedient if the guide section has a bore aligned parallel to the tube axis, in which an ejector is accommodated in a linearly movable manner, which ejector is coupled to an ejector slide mounted on the fluid tube in a linearly movable manner, whereby the ejector is accommodated in the bore in a rest position and projects axially from the guide section in an ejection position. The task of the ejector is to remove a pipetting tip held on the fluid tube from the fluid tube after use. It is assumed here that the pipetting tip is held positively on the fluid tube by the at least one locking hook during intended use of the pipette and is also held non-positively with frictional adhesion on the fluid tube by the elastic deformation caused when the pipetting tip is pushed onto the sealing section. After the end of the pipetting process of the coupling part along the tube axis, the latch is transferred from the latch position to the release position, whereby the positive coupling between the fluid tube and pipetting tip is released. However, at this point the force-locking connection between the sealing section and the pipetting tip still exists, so that a force application to the pipetting tip is required in order to push it off the sealing section, which force is oriented in the axial direction along the tube axis. This force is applied by the ejector, which is mounted for linear movement in the bore that passes through the guide section parallel to the tube axis. It is preferable for the ejector to come into contact with the pipetting tip with an end face arranged opposite the pipetting tip, thereby ensuring force transmission to the pipetting tip. The ejector slide coupled to the ejector is preferably coupled to a linear actuator, which can be designed in particular as an electric or electromagnetic actuator or as a fluidic actuator.

Preferably, a fluid source is connected to a second end region of the fluid tube facing away from the first end region of the fluid tube, which fluid source provides an overpressure and a negative pressure to the fluid tube, respectively. The fluid source has the task of providing a working fluid, in particular compressed air, at the orifice of the fluid tube in order to generate an overpressure in a pipetting tip which is coupled to the fluid tube, thereby enabling a liquid which is held in the pipetting tip to be dispensed. Furthermore, the fluid source has the task of at least partially withdrawing the working fluid from the fluid tube in order to generate a negative pressure in the pipetting tip, which is coupled to the fluid tube, thereby enabling a liquid in which the pipetting tip is immersed to be sucked in the pipetting tip. For example, the fluid source is designed as a syringe pump in which a syringe plunger can be moved by an actuator in order to generate the desired overpressure or underpressure in the fluid tube. Alternatively, the fluid source comprises a separately designed positive pressure pump and a separately designed negative pressure pump, which can be operated selectively to provide the desired positive pressure or negative pressure at the orifice of the fluid tube. The fluid source can also include one or more valve devices to support the targeted provision of positive pressure and negative pressure at the orifice of the fluid tube.

It is advantageous if a pipetting tip is arranged at the first end region of the fluid tube, which has a cannula section and a coupling sleeve adjoining the cannula section, wherein the coupling sleeve covers the guide section and has a radially inwardly projecting projection on an inner surface, against which the locking hook rests. The cannula section is preferably tapered starting from the coupling sleeve and has an outlet opening at an end region facing away from the coupling sleeve, the cross-section of which is considerably smaller than a central cross-section of the pipetting tip. The coupling sleeve is used to secure the pipetting tip to the fluid tube and in particular to the guide section. The coupling sleeve has at least one radially inwardly projecting projection on an inner surface, which forms an undercut with respect to the tube axis, so that the locking hook can exert a holding force on the pipetting tip aligned in the direction of the tube axis. It is particularly preferred that the inner surface of the coupling sleeve is rotationally symmetrical and that the projection is designed as a circumferential annular collar.

In a further embodiment of the invention, it is provided that a first inner diameter of the coupling sleeve is larger than a second inner diameter of the cannula section and that an axially aligned annular surface is formed between the inner surface of the coupling sleeve and an inner surface of the cannula section, which annular surface is arranged opposite an end face of the guide section. This annular surface is created by the abrupt change between the first inner diameter and the second inner diameter and serves in particular as a contact surface for the ejector in order to enable force transmission between the ejector and the pipetting tip, in which preferably only forces that are aligned parallel to the tube axis are transmitted. If necessary, it can be provided that the positioning of the annular surface is selected in such a way that when the pipetting tip is pushed onto the fluid tube, the annular surface rests flat against an opposite axial end face of the guide section, thereby ensuring a defined spatial position between the pipetting tip and the fluid tube, also in the direction of the tube axis.

In an advantageous further development of the invention, it is provided that a sealing region of an inner surface of the cannula section arranged adjacent to the coupling sleeve, in particular adjacent to the coupling sleeve, bears against the sealing section in a sealing manner. Preferably, the sealing area is rotationally symmetrical, in particular circular-cylindrical, and has an inner diameter that is slightly smaller than an outer diameter of the sealing section. This ensures that when the pipetting tip is pushed onto the fluid tube, an elastic deformation of the sealing area occurs due to the interaction with the sealing section, so that the desired sealing effect between the fluid tube and the pipetting tip is guaranteed.

### BRIEF DESCRIPTION OF THE DRAWINGS

An advantageous embodiment of the invention is shown in the drawing. It shows:

FIG. 1 shows an overall perspective view of a pipette,

FIG. 2 a partially sectioned overall view of the pipette according to FIG. 1,

FIG. 3 is an exploded perspective view of the pipette as shown in FIGS. 1 and 2,

FIG. 4 is a partial sectional perspective view of a front end region of the pipette shown in FIGS. 1 to 3,

FIG. 5 the pipette according to FIGS. 1 to 4 in a locked position,

FIG. 6 the pipette according to FIGS. 1 to 4 in an unlocked position, and

FIG. 7 the pipette according to FIGS. 1 to 4 in an eject position.

### DETAILED DESCRIPTION OF THE INVENTION

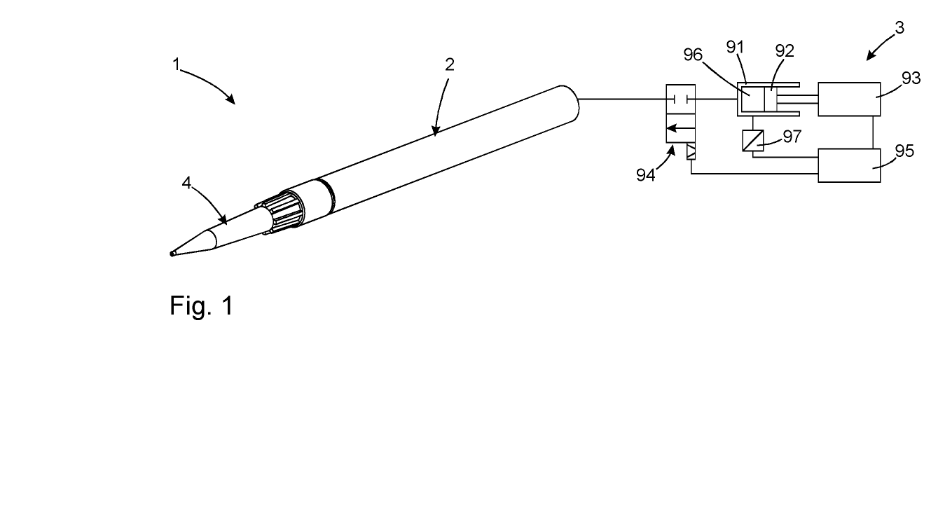

The pipette 1 shown in FIG. 1 is designed for dispensing liquids and can optionally be integrated into a handle for manual actuation by a user to enable manual handling of liquids, or can be accommodated in a pipetting device with which automated handling of liquids can be carried out.

The pipette 1 comprises a functional assembly 2 described in detail below, a pressure changing device, shown only schematically and designed in particular as a pump 3, and a disposable pipetting tip 4 fixed to the functional assembly 2. In particular, the function module 2 has the task of establishing or blocking a fluidic communicating connection between the pump 3 and the pipetting tip 4. It is assumed here that the pipetting tip 4 is used as a disposable item only for a limited number of liquid dosing processes and is then to be disposed of. In order to enable efficient handling of the pipette 1, it is therefore intended that the pipetting tip 4 can be removed with the aid of the functional assembly 2 from a carrier or container, in which preferably a plurality of pipetting tips 4 are held in the same spatial orientation in each case, and can be disposed of in a waste container, also not shown, at the end of use.

As will be described in more detail below, the pipetting tip 4 is coupled to the functional assembly 2 in such a way that only low support forces are necessary to pick up the pipetting tip 4 from the carrier or container during the coupling process, so that this carrier or container does not need to fulfil special stability requirements. Furthermore, the pipetting tip 4 is decoupled from the functional assembly 2 without the need to exert external supporting forces on the pipetting tip 2, so that a contact-free disposal process for the pipetting tip 2 can be achieved. Furthermore, it is provided that the pipetting tip 4 can be positively coupled to the functional assembly 2 so that during use of the pipetting tip 4, reaction forces, such as those that can occur, for example, when the pipetting tip 4 is used to pierce a sealing membrane of a liquid container and is afterwards removed from the liquid container, do not lead to undesired detachment of the pipetting tip 4 from the functional assembly 2.

The pump 3, which is only shown schematically, is designed purely as an example as a syringe pump and comprises a pump cylinder 91, a pump piston 92 accommodated in the pump cylinder 91 for linear movement, a linear actuator 93, an outlet valve 94 and a pump controller 95. The pump controller 95 is electrically connected to the linear actuator 93, which is designed for example as an electromechanical threaded spindle drive, and to the outlet valve 94, which is designed for example as a 2/2 solenoid valve. The pump controller 95 is set up to control the linear actuator 93 and the outlet valve 94 in such a way that the functional assembly 2 with the pipetting tip 4 attached to it can be supplied with either an overpressure or a negative pressure. A provision of an overpressure or a negative pressure is realized by the linear movement of the pump piston 92 in the pump cylinder 91, whereby it is assumed that a variable-size working space 96 delimited by the pump cylinder 91 and the pump piston 92 is filled with air. Preferably, the linear actuator 93 is actuated when the outlet valve 94 is closed, and the positive pressure or negative pressure in the working chamber 96 is only made available to the functional assembly 2 by an activation of the outlet valve 94 when a predetermined pressure level has been reached in the working space 96. This pressure level is monitored by a pressure sensor 97, which communicates fluidically with the working chamber 96 and is electrically connected to the pump controller 95.

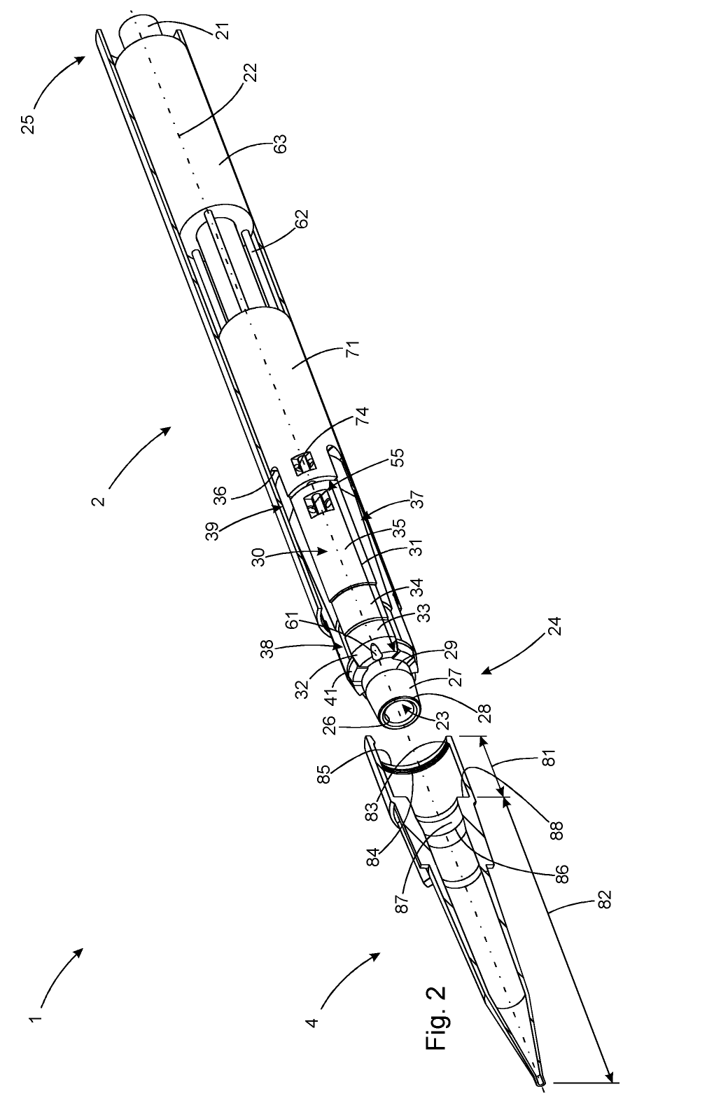

The functional assembly 2 shown in more detail in FIGS. 2 to 7 comprises a fluid tube 21 which extends along a pipe axis 22. By way of example only, the tube axis 22 is designed as a straight line and a fluid channel 23 bounded by the fluid tube 21 has a circular-cylindrical geometry. The pipetting tip 4 shown in FIGS. 1, 2 and 4 can be coupled to a first end region 24 of the fluid tube 21. The pump 3 is connected to a second end region 25 of the fluid tube 21 in a fluid-communicating manner, wherein the second end region 25 faces away from the first end region 24.

At the first end region 24, starting from a orifice 26, a section the fluid tube 21 has a conical section-shaped outer surface, which forms a sealing section 27 for the pipetting tip 4. It is provided here that the sealing section 27 tapers when viewed from the second end region 25 in the direction of the first end region 24. However, a minimum diameter 28 of the sealing section 27, which is present at the orifice 26, differs only slightly from a maximum diameter 29 of the sealing section 27, so that an undesignated cone angle for the sealing section 27, which angle may be in a range of 1 degree to 5 degrees, can be assumed.

Adjacent to the sealing section 27 extends a guide section 30, which is essentially rotationally symmetrical and which projects over the sealing section 27 over its entire longitudinal extent 31 along the tube axis 22 in the radial direction 53. As an example, it is provided that the guide section 30 is formed integrally with the fluid tube 21. Furthermore, it is provided that the guide section 30 has, adjacent to the sealing section 27, a centering section 32 which is tapered in the direction of the first end region 24 and which is adjoined, purely by way of example, by a total of three cylinder sections 33, 34, 35, wherein the cylinder section 35 has gradually larger, undesignated diameter compared with the diameters of the cylinder sections 33 and 34.

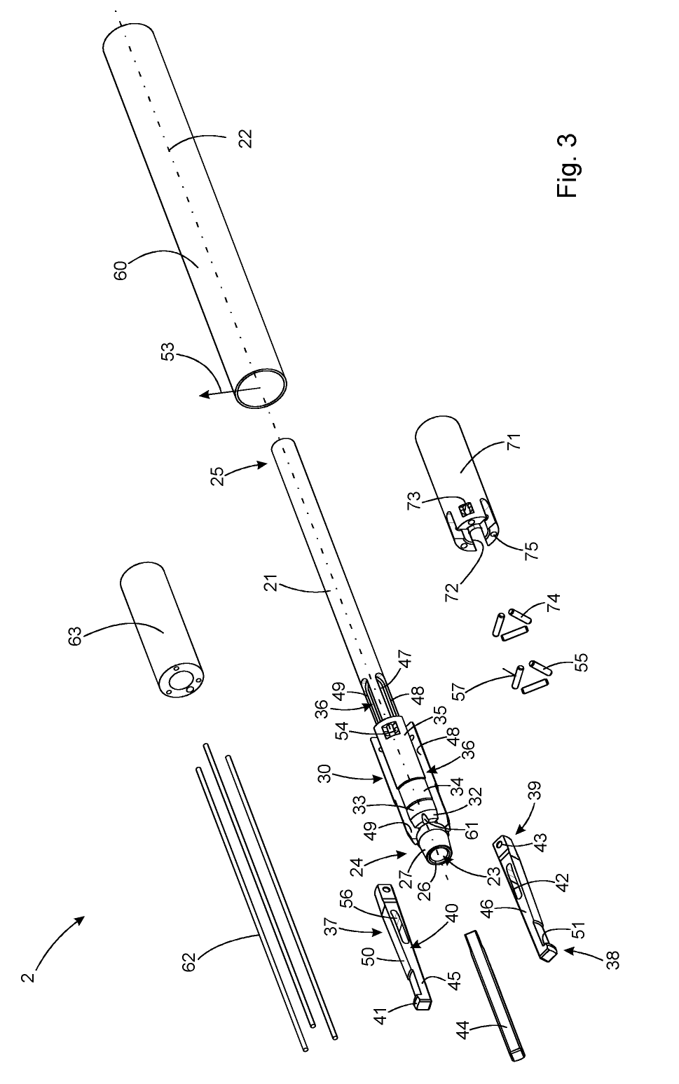

The guide section 30 is exemplarily provided with three guide grooves 36, each arranged offset by 120 degrees to the tube axis 22 and extended along the tube axis 22 with a constant profile in each case. As an example, it is provided that the guide grooves 36 extend along the tube axis 22 over the guide section 30, as can be seen in particular from FIG. 3.

In each of the guide grooves 36, a latch 37 is accommodated for linear movement, which has a strip-shaped latch body 40 and a latch hook 41. As can be seen from the illustration in FIG. 3, the latch body 40 has, by way of example only, a flat underside 44 and flat side surfaces 45, 46 aligned at right angles to the underside 44 and, in the position as shown in FIGS. 2 to 7, is aligned with a maximum extension along the tube axis 22. The guide grooves 36 are each formed with a flat base area 47 and flat side walls 48, 49 aligned at right angles thereto, wherein a distance between the side walls 48, 49 is slightly greater than a distance between the side surfaces 45, 46 of the latch 37. This results in a linear guidance with little play for the latch 37 in the respective guide groove 36.

The latch hook 41 is arranged at a first end region 38 of the latch 37 and extends in a radial direction outwards over an upper side 50 of the latch body 40. The latch hook 41 thus provides a latch surface 51 which is aligned transversely to the tube axis 22 and faces away from the first end region 38 of the latch 37 and thus points in the direction of a second end region 39 of the latch 37.

The latch body 40 is penetrated by a recess 42, which extends between the left side surface 45 and the right side surface 46. A geometry of the recess 42 can be described by an extension path 52 formed as a curve, which at least in some areas defines an acute angle with the tube axis 22. Furthermore, the latch body 40 is provided with a transverse bore 43 at the second end region 39, which is also extended between the left-hand side surface 45 and the right-hand side surface 46.

Each of the latches 37 is connected in an articulated manner to a coupling part 71, the coupling part 71 being sleeve-shaped and accommodated on the fluid tube 21 so that it can move linearly. For a linkage between the latch 37 and the coupling part 71, the coupling part 71 has, by way of example only, three incisions 72 which are adapted to the geometry of the respective latch 37, so that the second end region 39 of the latch 37 can be accommodated in the associated incision 72 in each case. Furthermore, the coupling part 71 is provided with three transverse bores 73, which are aligned at a 120 degree pitch to the tube axis 22 and in each case transverse to the tube axis 22 and transverse to the radial direction 53. A hinge pin 74 is accommodated in each of the transverse bores 73, which passes through the transverse bore 43 in the latch 37, thus forming a swivel joint between the coupling part 71 and the latch 37.

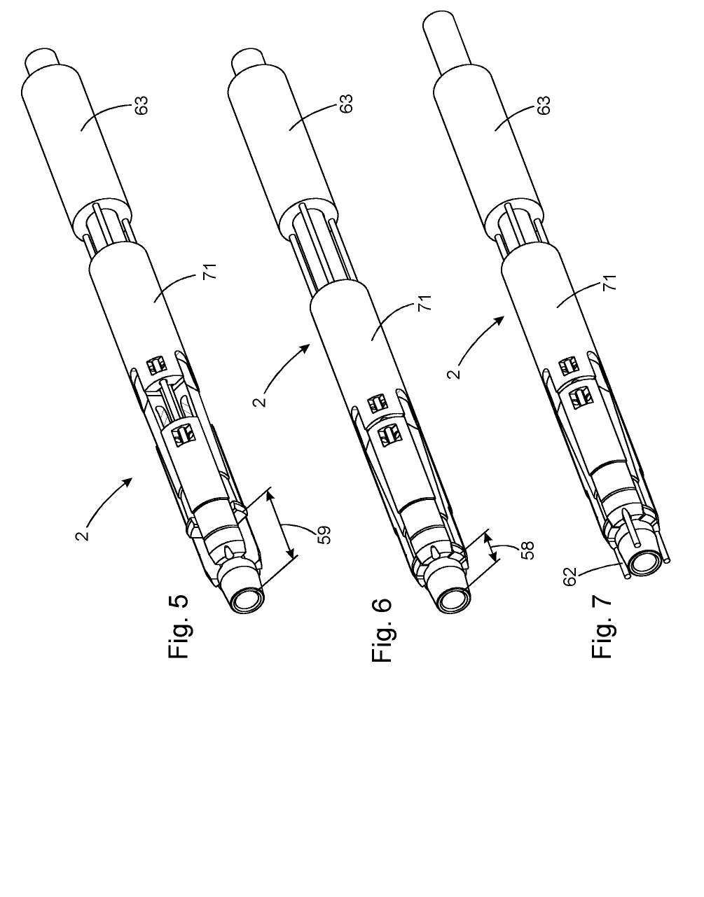

The guide section 30 is also provided with three transverse bores 54 which, in a similar manner to the transverse bores 73 in the coupling part 71, are each aligned transversely to the tube axis 22 and transversely to the radial direction 53 and each serve to receive a guide pin 55. Each of the guide pins 55 passes through the associated recess 42 in the latch 37, so that the guide pin 55 and the recess 42 each form a link guide or sliding guide. In the event of a linear relative movement of coupling part 71 and latch 37 with respect to the guide section 30, which takes place along the tube axis 22, a forced movement of the latch 37 in the radial direction 53 is additionally caused by this sliding guide, which is explained in more detail below in connection with FIGS. 5 to 7. Those areas of an inner surface of the recess 42 and an outer surface of the guide pin 55, which come into contact during the relative movement between the latch 37 and the guide pin 55, form a first control surface 56 in the case of the recess 42 and a second control surface 57 in the case of the outer surface of the guide pin 55. These two control surfaces 56, 57 define the link guide or sliding guide.

The linear relative movement of the coupling part 71 and the latch 37 connected thereto along the tube axis 22 can, for example, be caused by an actuator. which is either integrated into the functional assembly 2 or is arranged on the outside of the functional assembly 2. As an example, it may be provided that the coupling part 71 together with the fluid tube 21 form an electric linear motor in order to provide the desired relative movement between the coupling part 71 and the fluid tube 21.

The guide section 30 is also penetrated by longitudinal bores 61, each of which is aligned parallel to the tube axis 22. As an example, it is provided that the longitudinal bores 61 are arranged at a 120 degree pitch to the tube axis 22 and in each case centrally between adjacent guide grooves 36. A rod-shaped ejector 62, which is connected to a sleeve-shaped ejection slide 63 arranged coaxially to the fluid tube 21, is guided linearly in each of the longitudinal bores 61. The longitudinal bores 61 open out in the area of the centering section 32. The ejectors 62 and the ejection slide 63 are designed in such a way that the ejectors 62 can be moved from a neutral position shown in FIGS. 5 and 6, in which end regions of the ejectors 62 are received in the guide section 30, in the axial direction over the centering section 32 in the direction of the orifice 26 and thereby protrude over the guide section 30. Furthermore, the coupling part 71 is also provided with longitudinal bores 75, through which the ejectors 62 pass.

The linear relative movement of the ejector slide 63 and the associated ejectors 62 along the tube axis 22 can, for example, be caused by an actuator, which is either integrated into the functional assembly 2 or arranged on the outside of the functional assembly 2. As an example, it may be provided that the ejection slide 63 together with the fluid tube 21 form an electric linear motor in order to provide the desired relative movement between the ejection slide 63 and the fluid tube 21.

As can be seen from the illustrations in FIGS. 1 to 3, the functional assembly 2 has an outer tube 60 which partially encloses the fluid tube 21 and the guide section 30 and, in particular, covers the coupling part 71 and the ejection slide 63.

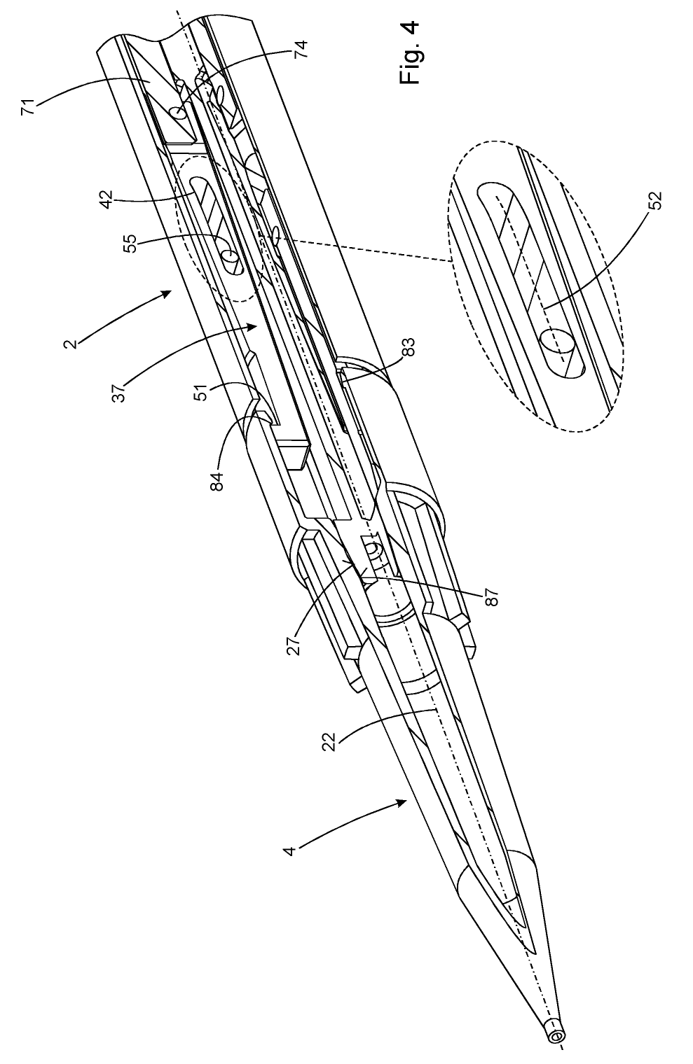

In FIG. 5, the functional assembly 2 is in a latched position or locking position for locking a pipetting tip 4, as shown in FIG. 4. In FIG. 6, the functional assembly 2 is in a neutral position. In FIG. 7, the function module 2 is in an ejection position for ejecting the pipetting tip 4.

In the illustration of FIG. 6, which shows the neutral position of the functional assembly 2, it can be seen that the coupling part 71 directly adjoins the guide section 30 in the axial direction and that the latch 37 has an axial distance from the orifice 26, which is also referred to as the release distance 58. Due to the interaction between the guide pin 55 and the recess 42 in the latch 37, the underside 44 of the latch 37 lies flat against the base area 47 of the guide groove 36. Furthermore, a radial extension of the latch hook 41 is adapted to the guide section 30 in such a way that the latch hook 41 does not protrude in the radial direction beyond an outer contour of the guide section 30, which can also be referred to as an envelope curve. In this neutral position, the functional assembly 2 can be brought closer to the pipetting tip 4 in such a way that the first end region 24 of the fluid tube 21 projects into a coupling sleeve 81 of the pipetting tip 4. Preferably, the tube axis 22 is aligned coaxially to the pipetting tip 4 and the first end region 24 of the fluid tube 21 only protrudes so far into the coupling sleeve 81 that in this stage no mechanical contact is made between the function assembly 2 and the pipetting tip 4.

Subsequently, while maintaining the relative position between the functional assembly 2 and the pipetting tip 4, a linear displacement of the coupling part 71 together with the latches 37 connected thereto is performed, whereby a distance between the guide section 30 and the coupling part 71 is increased. Accordingly, the distance between the orifice 26 and the latches 37 also increases until a latch distance 59 shown in FIG. 5 is reached. In the course of this linear relative movement of the coupling part 71 along the fluid tube 21, the interaction between the guide pins 55 accommodated in the guide section 30 and the recesses 42 in the latches 37 results in a superimposed linear and radial relative movement of the latches 37 with respect to the guide section 30, as a result of which the latch hooks 41 protrude in the radial direction 53 beyond the outer contour of the guide section 30. This results in the locking surfaces 51 of the latches 37 coming into contact with an annular collar 83 formed in the cannula section 82 and projecting inwards in a radial direction as a support surface 84, which produces a positive coupling between the latches 37 and the pipetting tip 4 acting in an axial direction along the axis of the tube. This positive coupling allows a tensile force to be transmitted from the latches 37 to the pipetting tip 4, which tensile forces cause a linear displacement of the pipetting tip 4 relative to the functional assembly 2. As a result, a cannula section 82 of the pipetting tip 4 is pulled at least partially onto the sealing section 27 of the fluid tube 21 and a sealing area 87 of the cannula section 82 is elastically deformed. This elastic deformation is based on the fact that an inner diameter of the cannula section 82 adjacent to the coupling sleeve 81 is slightly smaller than the maximum diameter 29 of the sealing section 27. As a result, the pipetting tip 4 is pulled onto the functional assembly 2 in a force-locking and sealing manner with respect to the sealing section 27 by the relative movement of the latch 37 with respect to the guide section 30 and is then available for carrying out pipetting operations. This locking position for the pipetting tip 4 is also shown in FIG. 4 and the combination of the functional assembly 2 and the pipetting tip 4 is ready for pipetting processes.

After the pipetting processes have been completed, the positive connection between the functional assembly 2 and the pipetting tip 4 can be released for the ejection of the pipetting tip 4 from the functional assembly 2 by first displacing the coupling part 71 and the latches 37 connected to it. In the course of this displacement of the coupling part 71, the latches 37 are brought back into the release position as shown in FIG. 6, in which the release distance 58 is present. This results in an unlocking with respect to form fit between the functional assembly 2 and the pipetting tip 4. Due to the area-wise elastic deformation of the cannula section 82 in interaction with the sealing section 27, it can be assumed that the pipetting tip 4 does not yet detach from the functional assembly 2 simply by moving the latches 37 into the neutral position as shown in FIG. 6. In order to ensure a reliable release process for the pipetting tip 4, it is therefore provided that the ejector slide 63 with the ejectors 62 attached thereto is brought closer to the coupling part 71 along the tube axis 22, so that the ejectors 62 project beyond the guide section 30 in the axial direction and can thereby exert an axial ejection force on the pipetting tip 4. The ejectors 62 and an actuator coupled to the ejection slide 63 are dimensioned in such a way that the frictional force between the cannula section 82 and the sealing section 27 can be overcome in order to produce the desired ejection movement.

In order to ensure an advantageous transmission of force from the ejectors 62 to the pipetting tip 4, it is provided that a first inner diameter 85 of the coupling sleeve 81 is significantly larger than a second inner diameter 86 of an area of the cannula section 82 arranged immediately adjacent to the coupling sleeve 81, also referred to as the sealing area 87. This creates an axially aligned annular surface 88 between the coupling sleeve 81 and the cannula section 82, against which the ejectors 62 come to rest when the ejection process is carried out.

1. A pipette, comprising a fluid tube which extends along a tube axis and has, at a first end region, a guide section which is designed in the shape of a circular cylinder or a conical section, wherein the guide section is provided with a guide groove extending along the tube axis, further comprising a latch being located in the guide groove so as to be movable between a latch position and a release position, wherein the latch has a latch body extending along the guide groove and a latch hook projecting radially outwards from the latch body, wherein the latch hook is received in the guide groove in the release position and wherein the latch hook projects radially outwards beyond the guide section in the latch position.

2. The pipette according to claim 1, wherein a first orifice is formed at the end of the first end region of the fluid tube and wherein the latch hook has a release distance from the first orifice in the release position and wherein the latch hook has a latch distance from the first orifice in the latch position, the latch distance being greater than the release distance.

3. The pipette according to claim 1, wherein the fluid tube has a conical sealing section which projects from the guide section along the tube axis and which is tapered in the direction of the first end region of the fluid tube.

4. The pipette according to claim 1, wherein a coupling part mounted for linear movement along the tube axis is arranged on the fluid tube, which coupling part is connected to the latch and is designed for transmitting an actuating movement to the latch.

5. The pipette according to claim 1, wherein a first control surface is formed on the latch and wherein a second control surface is formed on the guide section. the first control surface and the second control surface resting against one another at least in some areas and forming a link guide, by means of which a movement of the latch along the tube axis is superimposed on a movement of the latch transversely to the tube axis.

6. The pipette according to claim 5, wherein the latch is provided with a recess which is formed with a constant profiling transversely to the tube axis and wherein the first control surface is determined by an inner surface of the recess and wherein a pin which is aligned transversely to the tube axis is fixed to the guide section and passes through the recess and an outer surface of the pin forms the second control surface.

7. The pipette according to claim 1, wherein the guide section has a bore which is aligned parallel to the tube axis and in which an ejector is accommodated in a linearly movable manner and is coupled to an ejection slide which is mounted on the fluid tube in a linearly movable manner, the ejector being accommodated in the bore in a rest position and projecting in the axial direction from the guide section in an ejection position.

8. The pipette according to claim 1, wherein a fluid source is connected to a second end region of the fluid tube facing away from the first end region of the fluid tube. which fluid source is designed to provide an overpressure and a negative pressure to the fluid tube.

9. The pipette according to claim 1, wherein a pipetting tip is arranged at the first end region of the fluid tube, which pipetting tip has a cannula section and a coupling sleeve adjacent to the cannula section, wherein the coupling sleeve covers the guide section in some areas and has a radially inwardly projecting projection on an inner surface, against which the locking hook rests.

10. The pipette according to claim 9, wherein a first inner diameter of the coupling sleeve is larger than a second inner diameter of the cannula section and an axially aligned annular surface is formed between the inner surface of the coupling sleeve and an inner surface of the cannula section, which annular surface is arranged opposite an end face of the guide section.

11. The pipette according to claim 10, wherein a sealing region of an inner surface of the cannula section arranged adjacent to the coupling sleeve bears sealingly against the sealing section.
